(19) United States
(12) Patent Application Publication
(10) Pub. No.: US 2006/0161953 A1
(43) Pub. Date: Jul. 20, 2006

(54) System and method of providing a combined content guide for an entertainment system

(75) Inventors: Edward Walter, Boerne, TX (US); Yolius Diroo, San Antonio, TX (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 11/039,063

(22) Filed: Jan. 20, 2005

(51) Int. Cl. H04N 5/445; G06F 3/00; G06F 13/00

(52) U.S. Cl. 725/48; 725/49; 725/39

(57) ABSTRACT

A method of providing a combined content guide for a home entertainment system is provided and includes polling a first electronic device to receive a first set of content associated with the first electronic device. Further, a second electronic device is polled to receive a second set of content associated with the second electronic device. The first set of content is merged with the second set of content and with a third set of content associated with an on-screen programming guide from a content provider to yield a combined content guide for the home entertainment system. The method further includes polling a third electronic device to receive a fourth set of content associated with the third electronic device. The fourth set of content can be incorporated into the combined content guide.

### FIELD OF THE DISCLOSURE

The present disclosure relates to entertainment systems.

### BACKGROUND

A home entertainment system can include multiple components. For example, a home entertainment system can include a compact disc (CD) player, a digital video disc (DVD) player, an audio receiver, a set top box, a television, and several speakers. Typically, the CD player and the DVD player can hold multiple discs and include a “jukebox” type function. As the number of discs that are loaded within the CD player and the DVD player increases, the difficulty of knowing which discs are loaded increases. Thus, the difficulty of knowing the total content provided by the home entertainment system increases.

Accordingly, there is a need for an improved system and method of managing content for an entertainment system.

### BRIEF DESCRIPTION OF THE DRAWINGS

The present invention is pointed out with particularity in the appended claims. However, other features are described in the following detailed description in conjunction with the accompanying drawings in which:

FIG. 1 is a block diagram representative of a home entertainment system;

FIG. 2 is a flow chart to illustrate a method of providing a combined content guide for an entertainment system; and

FIG. 3 is a general diagram of a television and a combined content guide for an entertainment system.

### DETAILED DESCRIPTION OF THE DRAWINGS

A method of providing a combined content guide for a home entertainment system is provided and includes polling a first electronic device to receive a first set of content associated with the first electronic device. Further, a second electronic device is polled to receive a second set of content associated with the second electronic device. The first set of content is merged with the second set of content and with a third set of content associated with an on-screen programming guide from a content provider to yield a combined content guide for the home entertainment system.

In a particular embodiment, the method further includes polling a third electronic device to receive a fourth set of content associated with the third electronic device. The fourth set of content can be incorporated into the combined content guide. Further, the method can include polling a fourth electronic device to receive a fifth set of content associated with the fourth electronic device. The fifth set of content can also be incorporated into the combined content guide.

In a particular embodiment, the first electronic device can be a compact disc player. Moreover, the first set of content can represent one or more compact discs that are within the compact disc player. The second electronic device can be a digital video disc player. Also, the second set of content can represent one or more digital video discs that are within the digital video disc player. The third electronic device can be an audio receiver and the fourth set of content can represent one or more songs received at the audio receiver via frequency modulation radio waves or amplitude modulation radio waves. Further, in a particular embodiment, the fourth electronic device can be an MP3 player and the fifth set of content represents one or more MP3 files stored within the MP3 player.

In another embodiment, a method of providing an on-screen program guide for a home entertainment system is provided and includes receiving a first set of content, a second set of content, and a third set of content. Thereafter, the first set of content, the second set of content, and the third set of content are combined to yield the on-screen program guide for the home entertainment system.

In yet another embodiment, an entertainment system is provided and includes an audio receiver. A television can be coupled to the audio receiver and a digital video disc player coupled to the television and to the audio receiver. Additionally, a set top box can be coupled to the television and to the audio receiver. The set top box can include a computer readable medium and a computer program embedded therein. In a particular embodiment, the computer program can include instructions to receive a first set of content associated with an on-screen programming guide. Further, the computer program can include instructions to periodically poll the digital video disc player to receive a second set of content. Also, the computer program can include instructions to combine the first set of content and the second set of content to provide a combined content guide.

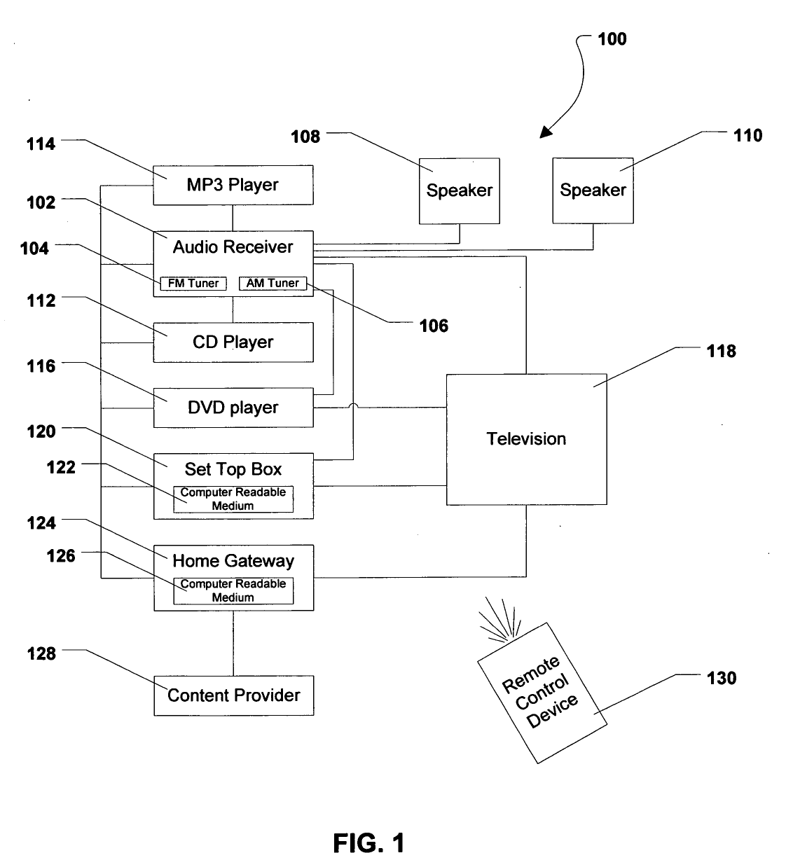

Referring to FIG. 1, a home entertainment system is illustrated and is generally designated 100. As depicted in FIG. 1, the home entertainment system 100 includes an audio receiver 102. In a particular embodiment, the audio receiver 102 can include a frequency modulation (FM) radio tuner 104 and an amplitude modulation (AM) radio tuner 106. FIG. 1 further shows a first speaker 108 and a second speaker 110 that are coupled to the audio receiver 102.

As shown in FIG. 1, a compact disc (CD) player 112 and an MP3 player 114 are also coupled to the audio receiver. Moreover, a digital video disc (DVD) player 116 is coupled to the audio receiver 102. FIG. 1 also shows that a television 118 is coupled to the audio receiver 102 and to the DVD player 116. Further, as indicated in FIG. 1, a set top box 120 is coupled to the audio receiver 102 and to the television 118. In a particular embodiment, the set top box 120 includes a computer readable medium 122, such as a memory device.

FIG. 1 also shows that the system 100 can include a home gateway 124. In a particular embodiment, the home gateway 124 can include a computer readable medium 126, such as a memory device. Further, in an illustrative embodiment, the audio receiver 102, the CD player 112, MP3 player 114, the DVD player 116, and the set top box 120 can be network to the home gateway 124, e.g., via a fire wire network. Further, during operation, as described in detail below, the home gateway 124 can poll each electronic device that is coupled thereto in order to determine the content that is available at each electronic device that content can be combined to create a single combined content guide that includes all of the content that is available at the home entertainment system 100. In an alternative embodiment, the set top box 120 can act as a home gateway and the other components can be networked to the set top box 120. In such an embodiment, the set top box 120 can poll each electronic device to determine the content available at each device and create the combined content guide.

In yet another alternative embodiment, the content provider 128 can poll each electronic device and the combined content guide can be created at the content provider 128 and then, transmitted back to the home entertainment system 100. In this embodiment, the content provider 128 can include a separate repository for storing personal content for each customer. Further, a customized combined content guide can be created for each customer and transmitted thereto when requested. Additionally, when the content provider 128 is responsible for creating and managing the combined content guides for the customers, the content provider 128 can communicate with the individual devices in the home entertainment system 100 via a wide area network (WAN) established using one or more broadband connections. Further, each device in the home entertainment system 100 can include a unique Internet protocol (IP) address.

As shown in FIG. 1, the home gateway 124 can also be coupled to a content provider 128. For example, the home gateway 124 can be coupled to the content provider 128 via a broadband cable or DSL connection. As further illustrated in FIG. 1, the home entertainment system 100 can include a remote control device 130. The remote control device 130 can be used to control the audio receiver 102, the CD player, the MP3 player 114, the DVD player 116, the television 118, or the set top box 120.

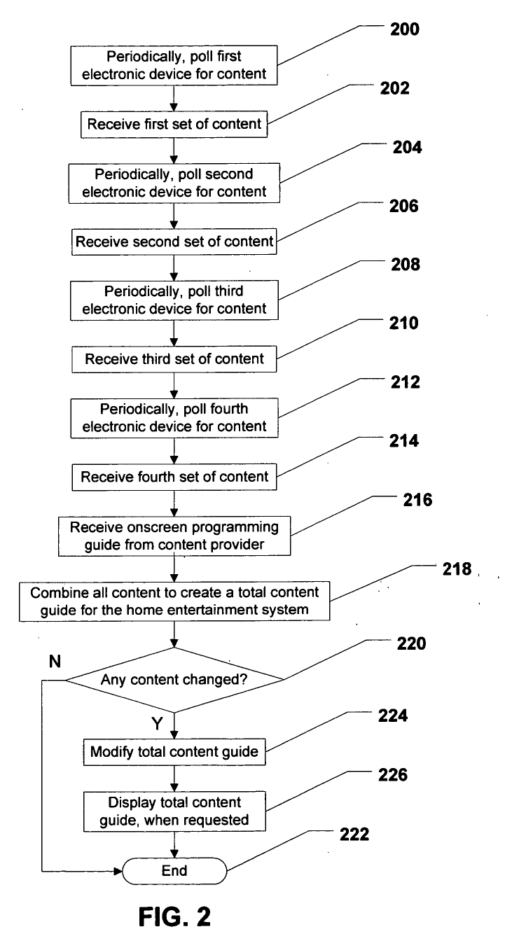

Referring to FIG. 2, a method of creating a combined content guide is shown and commences at block 200. At block 200, a home gateway periodically polls a first electronic device for content. In a particular embodiment, the first electronic device is a DVD player, e.g., a DVD jukebox that contains a plurality of DVDs. At block 202, the home gateway receives a first set of content from the first electronic device. Particularly, the first set of content represents a list of DVDs that are loaded in the DVD player.

Moving to block 204, the home gateway periodically polls a second electronic device for content. In a particular embodiment, the second electronic device is a CD player, e.g., a multi-disc CD player containing a plurality of CDs. At block 206, the home gateway receives a second set of content from the second electronic device. Particularly, the second set of content represents a list of CDs that are loaded in the CD player. Continuing to block 208, the home gateway periodically polls a third electronic device for content. In a particular embodiment, the third electronic device is an Audio receiver that has an FM tuner and an AM tuner. At block 21 0, the home gateway receives a third set of content from the third electronic device. In a particular embodiment, the third set of content represents a list of FM and AM radio stations and associated programs that are available at the audio receiver.

Proceeding to block 212, the home gateway periodically polls a fourth electronic device for content. Particularly, the fourth electronic device is an MP3 player. At block 214, the home gateway receives a fourth set of content from the fourth electronic device. In a particular embodiment, the fourth set of content is a list of audio files that are stored in the MP3 player. Moving to block 216, the home gateway receives a fifth set of content from a content provider. In a particular embodiment, the fifth set of content is an on-screen programming guide. Further, the on-screen programming guide can be received directly at the home gateway or the on-screen programming guide can be received via a set top box that is coupled to the home gateway.

Continuing to block 218, the home gateway combines all of the received content sets to create a combined content guide for the home entertainment system. In a particular embodiment, all content whether private or public can be combined into a single converged content guide. At decision step 220, the home gateway determines whether any of the content from electronic devices coupled thereto has changed. If not, the logic ends at state 222. At decision step 220, if any of the content has changed, the method moves to block 224 and the home gateway modifies the combined content guide. Thereafter, when requested by a user, the home gateway displays the combined content guide at the television at block 226. The method then ends at state 222. In an alternative embodiment, the method described herein can be performed by a set top box instead of a home gateway.

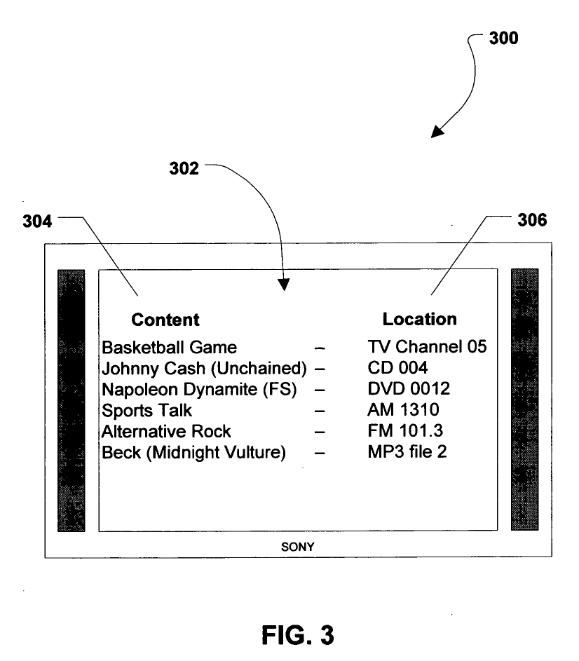

FIG. 3 shows a television, generally designated 300. As illustrated in FIG. 3, a combined content guide 302 can be presented at the television 300, e.g., by a set top box or a home gateway that is coupled to the television 300. FIG. 3 shows that the combined content guide 302 includes a content list 304 and a location list 306. In an exemplary embodiment, the content list 304 includes a list of content that is available for viewing or listening via a home entertainment system. For example, the content list 304 can include content that is available via a set top box, e.g., one or more television programs or sports events. Also, the content list 304 can include one or more CDs that are loaded into a CD player, one or more DVDs that are loaded into a DVD player, or one or more audio files that are stored within an MP3 player. Further, the content list 304 can include one or more AM radio stations or FM radio stations that are available at an audio receiver. The content list 304 can also include the title of the items on the content list. Also, for DVDs, the content list 304 can indicate the aspect ratio in which the DVD content is presented, e.g., full screen (FS) or wide screen (WS).

As shown in FIG. 3, the location list 306 includes a location of each item on the content list. For example, the location list 306 can indicate the channel number of a particular television show or sporting event. Further, the location list 306 can indicate a CD tray number associated with a CD listed on the content list 304 or a DVD tray number associated with a DVD listed on the content list 304. Additionally, as indicated in FIG. 3, the location list 306 can also include an AM radio station dial location or FM radio station dial location associated with an AM radio station or FM radio station shown on the content list 304. Moreover, the location list 306 can include a file number associated with an MP3 file on the content list 304.

In a particular embodiment, when a particular item on the content list 304 is selected, a command can be sent to the appropriate device in the home entertainment system in order to activate that device and being playing the selected item. For example, if a particular CD is selected, a command can be sent to the CD player and the selected CD can be loaded and begin playing. Also, a command can be sent to the audio receiver in order to select the input channel at the audio receiver that corresponds to the CD player. Additionally, in a particular embodiment, when a particular item, such as a DVD, is selected, a command can be sent to the DVD player to load the selected DVD. Another command can be sent to the DVD player to select the input channel at the audio receiver that corresponds to the DVD player input. Moreover, another command can be sent to the audio receiver to select the appropriate sound settings for the selected DVD. For example, the command can activate Dolby Digital Surround Sound at the audio receiver if is available.

With the configuration of structure described above, the system and method of providin a combined content guide for an entertainment system provides a way for a user to quickly and easily determine which content is available at the entertainment sustem.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing a combined content guide for a home entertainment system, comprising:
polling a first electronic device to receive a first set of content associated with the first electronic device;
polling a second electronic device to receive a second set of content associated with the second electronic device; and
merging the first set of content with the second set of content and with a third set of content associated with an on-screen programming guide from a content provider to yield a combined content guide for the home entertainment system.

2. The method of claim 1, further comprising polling a third electronic device to receive a fourth set of content associated with the third electronic device.

3. The method of claim 2, further comprising incorporating the fourth set of content into the combined content guide.

4. The method of claim 3, further comprising polling a fourth electronic device to receive a fifth set of content associated with the fourth electronic device.

5. The method of claim 4, further comprising incorporating the fifth set of content into the combined content guide.

6. The method of claim 5, wherein the first electronic device is a compact disc player.

7. The method of claim 6, wherein the first set of content represents one or more compact discs within the compact disc player.

8. The method of claim 6, wherein the second electronic device is a digital video disc player.

9. The method of claim 8, wherein the second set of content represents one or more digital video discs within the digital video disc player.

10. The method of claim 8, wherein the third electronic device is an audio receiver.

11. The method of claim 10, wherein the fourth set of content represents one or more songs received at the audio receiver via frequency modulation radio waves or amplitude modulation radio waves.

12. The method of claim 10, wherein the fourth electronic device is an MP3 player.

13. The method of claim 12, wherein the fifth set of content represents one or more MP3 files stored within the MP3 player.

14. A method of providing an on-screen program guide for a home entertainment system, comprising:
receiving a first set of content;
receiving a second set of content;
receiving a third set of content; and
combining the first set of content, the second set of content, and the third set of content to yield the on-screen program guide for the home entertainment system.

15. The method of claim 14, further comprising receiving a fourth set of content.

16. The method of claim 15, further comprising combining the fourth set of content, the first set of content, the second set of content, and the third set of content to yield the on-screen program guide for the home entertainment system.

17. The method of claim 16, further comprising selectively displaying the on-screen program guide at a display device.

18. The method of claim 17, further comprising modifying the on-screen program guide for the home entertainment system as changes are made to at least one of: the first set of content, the second set of content, the third set of content, and the fourth set of content.

19. The method of claim 18, wherein the first set of content represents a list of programs available via a content provider.

20. The method of claim 19, wherein the second set of content represents a list of compact discs available via a compact disc player.

21. The method of claim 20, wherein the third set of content represents a list of digital video discs available via a digital video disc player.

22. The method of claim 21, wherein the fourth set of content represents a list of MP3 files available via an MP3 player.

23. An entertainment system, comprising:
an audio receiver;
a television coupled to the audio receiver;
a digital video disc player coupled to the television and to the audio receiver;
a set top box coupled to the television and to the audio receiver, the set top box including a computer readable medium and a computer program embedded therein, wherein the computer program comprises;
instructions to receive a first set of content associated with an on-screen programming guide;
instructions to periodically poll the digital video disc player to receive a second set of content; and
instructions to combine the first set of content and the second set of content to provide a combined content guide.

24. The system of claim 23, further comprising a compact disc player coupled to the audio receiver.

25. The system of claim 24, wherein the computer program further comprises instructions to periodically poll the compact disc player to receive a third set of content.

26. The system of claim 25, wherein the computer program further comprises instructions to combine the third set of content with the first set of content and the second set of content to provide the combined content guide.

27. The system of claim 26, wherein the computer program further comprises instructions to periodically poll the audio receiver to receive a fourth set of content.

28. The system of claim 27, wherein the computer program further comprises instructions to combine the fourth set of content with the first set of content, the second set of content, and the third set of content to provide the combined content guide.

29. The system of claim 28, further comprising an MP3 player coupled to the audio receiver.

30. The system of claim 29, wherein the computer program further comprises instructions to periodically poll the MP3 player to receive a fifth set of content.

31. The system of claim 30, wherein the computer program further comprises instructions to combine the fifth set of content with the first set of content, the second set of content, the third set of content, and the fourth set of content to provide the combined content guide.

32. The system of claim 31, wherein the second set of content represents one or more digital video discs within the digital video disc player, wherein the third set of content represents one or more compact discs within the compact disc player, wherein the fourth set of content represents one or more radio stations received at the audio receiver via frequency modulation radio waves or amplitude modulation radio waves, and wherein the fifth set of content represents one or more MP3 files stored within the MP3 player.

33. The system of claim 31, wherein the computer program further comprises instructions to selectively display the combined content guide at the display device.

34. The system of claim 33, wherein the computer program further comprises instructions to change the on-screen program guide for the home entertainment system to reflect changes made to at least one of: the first set of content, the second set of content, the third set of content, the fourth set of content, and the fifth set of content.
